(19) United States
(12) Patent Application Publication
(10) Pub. No.: US 2023/0158784 A1
(43) Pub. Date: May 25, 2023

(54) VEHICLE COMPONENT UNIT AND METHOD FOR PRODUCING A VEHICLE COMPONENT UNIT

(71) Applicants: Teijin Limited, Osaka (JP); Teijin Automotive Technologies, Inc., Auburn Hills, MI (US)

(72) Inventors: Tsukasa Arai, Osaka (JP); Hugh Foran, Auburn Hills, MI (US); Matthew Plauman, Auburn Hills, MI (US); Evan Freeman-Gibb, Auburn Hills, MI (US)

(73) Assignees: Teijin Limited, Osaka (JP); Teijin Automotive Technologies, Inc., Auburn Hills, MI (US)

(21) Appl. No.: 17/917,071

(22) PCT Filed: Apr. 2, 2021
(86) PCT No.: PCT/US2021/025506

§ 371 Date: Oct. 5, 2022

Related U.S. Application Data
(60) Provisional application No. 63/005,698, filed on Apr. 6, 2020.

(51) Int. Cl. B32B 27/08; B32B 7/12; B32B 5/18; B32B 27/20; B32B 27/40

(52) U.S. Cl. CPC B32B 27/08; B32B 7/12; B32B 5/18; B32B 27/20; B32B 27/40; B32B 2250/04; B32B 2305/08; B32B 2307/406; B32B 2605/00

(57) ABSTRACT

A vehicle component unit including a reinforcing open area core layer, a high gloss surface layer, and an encapsulating plastic layer. The reinforcing open area core layer has a first side and an oppositely opposed second side and a first end and an oppositely opposed second end each extending between the first side and the second side. The high gloss surface layer is positioned on the first side of the reinforcing open area core layer. The encapsulating plastic layer has a first end and a second end and is positioned on the second side of the reinforcing open are core layer. The first end and the second end of the encapsulating plastic layer are embedded into the high gloss surface layer with an embedded length L, such that the encapsulating plastic layer covers the first end and the second end of the reinforcing open area core layer.

### CROSS-REFERENCE TO RELATED APPLICATION

This application claims priority of U.S. Provisional Patent Application Ser. No. 63/005,698 filed Apr. 6, 2020, which is incorporated herein by reference.

### FIELD OF THE INVENTION

The present invention in general relates to composites and in particular to a composite sandwich structure assembly with an intervening open area core support matrix and surface sheets adhered to the open area core to provide at least one surface that meets vehicle exterior surface gloss standards.

### BACKGROUND OF THE INVENTION

Weight savings in the automotive, transportation, and logistics based industries has been a major focus in order to make more fuel efficient vehicles both for ground and air transport. In order to achieve these weight savings, light weight composite materials have been introduced to take the place of metal structural and surface body components and panels. Composite materials are materials made from two or more constituent materials with significantly different physical or chemical properties, that when combined, produce a material with characteristics different from the individual components. The individual components remain separate and distinct within the finished structure. A composite material may be preferred for many reasons: common examples include materials which are stronger, lighter, or less expensive when compared to traditional materials. A sandwich-structured composite is a special class of composite material that is fabricated by attaching two thin but stiff skins to a lightweight but thick core. The core material is normally a low strength material, but its higher thickness provides the sandwich composite with high bending stiffness with overall low density.

While sandwich structures have previously been developed to provide strength and reduced weight, the ability to obtain a vehicle exterior quality high gloss surface has remained a challenge, regardless of whether the surface outermost layer is thermoset resin or thermoplastic. It is conventional to either not use such structures in settings where vehicle high surface gloss is required, or resort to an additional outer layer to provide a high gloss outermost layer. Such outermost layers can be applied after structure production or through in mold coatings, both of which add to the cost and complexity of production.

Still another problem conventional to the art is that sandwich structure edges often require an additional processing step of cutting excess material from the vehicle component, resulting in edges that are ineffective and allow for infiltration of humidity or moisture that becomes entrained within the core and often inconsistent with finished vehicle surface requirements. With temperature extremes this entrained moisture can reduce the operational lifetime of the structure, while increasing the weight thereof. These problems of moisture infiltration are particularly pronounced in instances when the core is formed of cellulosic materials such as paper.

Thus, there exists a need for a sandwich composite structure vehicle component that affords a high gloss surface, moisture resistance, and well-trimmed edges without resort to additional processing after production or the addition of further outermost surface layers.

### SUMMARY OF THE INVENTION

The present invention provides a vehicle component unit that includes a reinforcing open area core layer, a high gloss surface layer, and an encapsulating plastic layer. The reinforcing open area core layer has a first side and an oppositely opposed second side and a first end and an oppositely opposed second end each extending between the first side and the second side. The high gloss surface layer is positioned on the first side of the reinforcing open area core layer. The encapsulating plastic layer has a first end and a second end and is positioned on the second side of the reinforcing open are core layer. The first end and the second end of the encapsulating plastic layer are embedded into the high gloss surface layer with an embedded length L, such that the encapsulating plastic layer covers the first end and the second end of the reinforcing open area core layer.

The present invention additionally provides a method for producing the above-described vehicle component unit. The method includes stacking the high gloss surface layer, the open area core layer, and the encapsulating plastic layer in a mold having an upper portion and a lower portion that together define a mold cavity, inserting the ends of the encapsulating plastic layer into the high gloss surface layer using sharp edges on the mold and simultaneously trim the encapsulating plastic layer and the open area core layer using the sharp edges on the mold, and pressing the upper portion of the mold and the lower portion of the mold together to impart a shape to the vehicle component.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows a cross sectional view a vehicle component according to embodiments of the present invention;

FIG. 2 shows a cross sectional detailed view illustrating the end portion of the internal plastic layer inserted in the SMC layer of the vehicle component of FIG. 1;

FIG. 3 shows a cross sectional view a vehicle component according to embodiments of the present invention;

FIG. 4 shows a cross sectional detailed view illustrating the end portion of the internal plastic layer inserted in the SMC layer of the vehicle component of FIG. 3 illustrating the length L and the thickness T1 of the SMC layer;

FIG. 5 shows a cross sectional view a vehicle component according to embodiments of the present invention;

FIG. 6 shows a cross sectional view a vehicle component according to embodiments of the present invention;

FIG. 7 shows a cross sectional detailed view illustrating the end portion of the internal plastic layer inserted in the SMC layer of the vehicle component according to embodiments of the present invention illustrating the length L and the thickness T1 of the SMC layer;

FIG. 8 shows a cross sectional detailed view illustrating the end portion of the internal plastic layer inserted in the SMC layer of the vehicle component according to embodiments of the present invention illustrating the region X, the thickness T1, T2 and the length L;

FIG. 9 shows a cross sectional view a vehicle component according to embodiments of the present invention having a thickness Tm of the vehicle component and the thickness Tc of the core layer;

FIG. 10 shows a cross sectional detailed view illustrating the end portion of the internal plastic layer inserted in the SMC layer of the vehicle component according to embodiments of the present invention illustrating the thickness Tm of the vehicle construction unit and the thickness Tc of the core layer;

FIG. 11 shows a cross sectional view a vehicle component according to embodiments of the present invention illustrating the thickness Tm of the vehicle component and the thickness Tc of the core layer;

FIG. 12 shows a cross sectional view a vehicle component according to embodiments of the present invention illustrating the thickness Tm of the vehicle component and the thickness Tc of the core layer;

FIG. 13A shows a cross sectional view illustrating a method for producing a vehicle component according to embodiments of the present invention with an upper mold and a lower mold before the molds closed;

FIG. 13B shows a cross sectional view illustrating a method for producing a vehicle component according to embodiments of the present invention with the molds after the mold closed;

FIG. 13C shows a cross sectional view illustrating a method for producing a vehicle component according to embodiments of the present invention with the molds after the mold closed;

FIG. 14A shows a cross sectional view illustrating a sharp edge inserting the end portion of the internal plastic layer into the SMC layer before the mold closed;

FIG. 14B shows a cross sectional view illustrating a sharp edge inserting the end portion of the internal plastic layer into the SMC layer after the mold closed;

FIGS. 15A and 15B show cross sectional views illustrating a secondary trimming process of a vehicle component according to a conventional method; and

FIGS. 16A-16C show cross sectional views illustrating a method of forming a vehicle component according to embodiments of the present invention using a masking method.

### DESCRIPTION OF THE INVENTION

The present invention has utility as a composite sandwich vehicle component with an open area core sandwiched between and encapsulated within a sheet molding compound (SMC) layer and an encapsulating plastic layer and a method of producing the same. The SMC layer has a high gloss surface finish such that secondary finishing of the vehicle component to obtain a high gloss surface finish is avoided. The present invention is suitable for all vehicle components made of composite material, but in particular for vehicle body shell components, such as vehicle roof modules, a cover of a roof opening system such as a sliding roof or spoiler roof, a surface component of a roof module, roof posts, A, B, C or D pillars of vehicles, vehicle doors, wings, engine compartment covers, luggage compartment covers, rear-end modules, roof shells of cabriolet hoods, a trim component of a vehicle, or front or rear spoilers. Embodiments of the present invention further provide sound dampening and temperature variation resistance qualities. Additionally, the inventive method and vehicle component of the present invention provide a vehicle component that is finished at the ends thereof to additionally avoid secondary trimming or cutting of the vehicle component after molding of the vehicle component. The result is a low cost, light weight, high strength vehicle component that is finished with a high quality of aesthetics upon completion of the molding process.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

As used herein, the term “high gloss surface” refers to a surface having minimal perceptible surface defects when visually inspected for about three seconds from about 24-28 inches from the viewer and normal to the part surface +/−90 degrees in a well-lit area. That is, the term “high gloss surface” refers to a surface capable of being painted and accepted as a “Class A” autobody part. This is commonly measured by ASTM D523. In the automotive industry, a Class A surface is a surface a consumer can see without functioning the vehicle (e.g., opening the hood or decklid), while a Class A surface finish generally refers to painted outer panels and specifically to the distinctness of image (DOI) and gloss level on the part. It is appreciated that a surface layer may be subjected to sanding, trimming, and priming prior to receiving a paint coating that imparts high gloss yet must retain dimensionality and adhesion uniformity to primer and paint so as to achieve a high gloss finish.

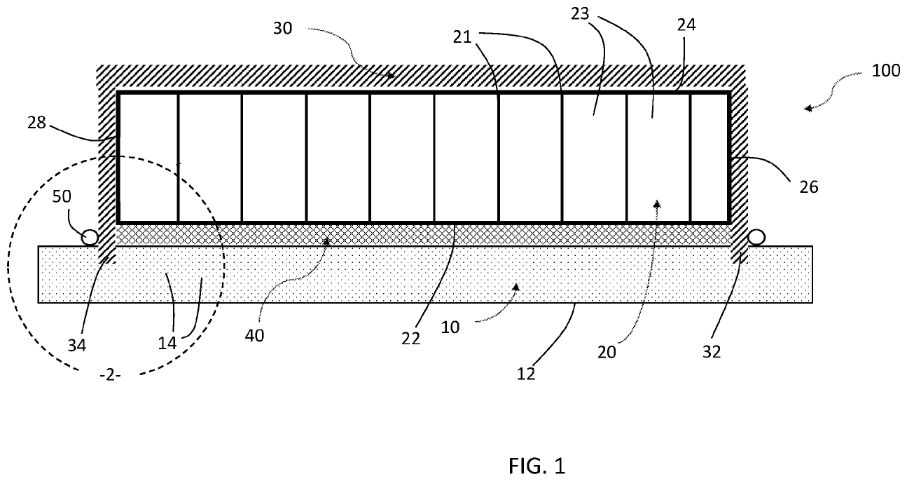

Referring now to the figures, a vehicle component 100 according to embodiments of the present invention comprises a high gloss surface layer 10, a reinforcing open area core layer 20, and an encapsulating plastic layer 30. The reinforcing open area core 20 has a first side 22 and an oppositely opposed second side 24 and a first end 26 and an oppositely opposed second end 28 each extending between the first side 22 and the second side 24. The high gloss surface layer 10 is positioned on the first side 22 of the reinforcing open area core layer 20 with the high gloss surface 12 positioned such that it is outwardly facing, that is, facing away from the open area core layer 20. The encapsulating plastic layer 30 is positioned on the second side 24 of the reinforcing open area core layer 20. The encapsulating plastic layer 30 has a first end 32 and a second end 34 that are embedded into the high gloss surface layer 10 with an embedded length L, such that the encapsulating plastic layer 30 covers the first end 26 and the second end 28 of the reinforcing open area core layer 20. While the structure 100 depicted in FIG. 1 is planar, it is appreciated that both the high gloss surface layer 10 and the encapsulating plastic layer 30 can each independently be formed with non-planar contours.

The high gloss surface layer 10 according to the present invention is formed from sheet molding compound (SMC), thermoplastic, dicyclopentadiene (DCPD), overmolded polyurethane (PU), or a combination thereof. According to embodiments, the high gloss surface layer 10 includes a filler material 14 to reinforce and/or serve to decrease the weight of the high gloss surface layer 10. The filler material 14 is any of glass fibers, carbon fibers, basalt fibers, natural fibers, hollow or solid glass microspheres, a fiber mat, or a combination thereof. The fibers may be oriented or non-oriented. It is appreciated that the high gloss layer 10 routinely includes additives to retain dimensionality. Such additives routinely including glass fiber; carbon fiber; inorganic particulate fillers such as calcium carbonate, talc, and carbon black; glass microspheres; carbon nanotubes; graphene; low profile additives; moisture scavengers; and combinations thereof. Typical thicknesses of the high gloss surface layer in the present invention range from 0.5 to 5 millimeters (mm) without regard to edges. According to embodiments, the high gloss surface layer 10 is formed on a thermosetting SMC containing short dispersed fibers. A high-gloss surface is obtained either by a corresponding high-gloss surface in a mold or by subsequent polishing of the component. High-gloss, matt or structured component surfaces are obtained in accordance with the mold surface. According to embodiments, the high gloss surface layer 10 includes contrasting colors or be made in the color of the paint color of the final vehicle. According to embodiments, the high gloss surface layer 10 exhibits a reduced density of smaller than 1.4 kg/dm³ and in particular between 1.3 kg/d m³ and 1.0 kg/d m³.

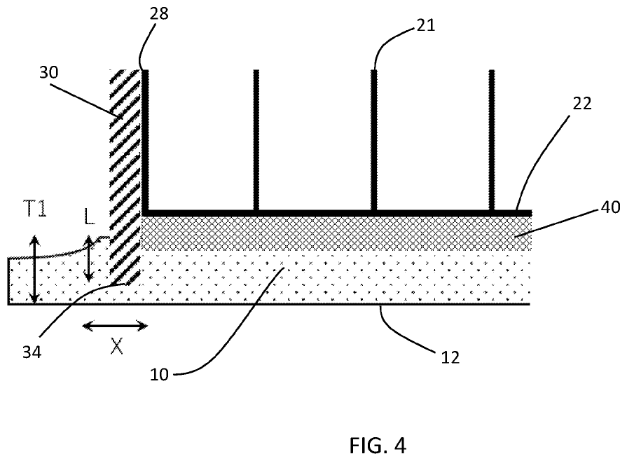

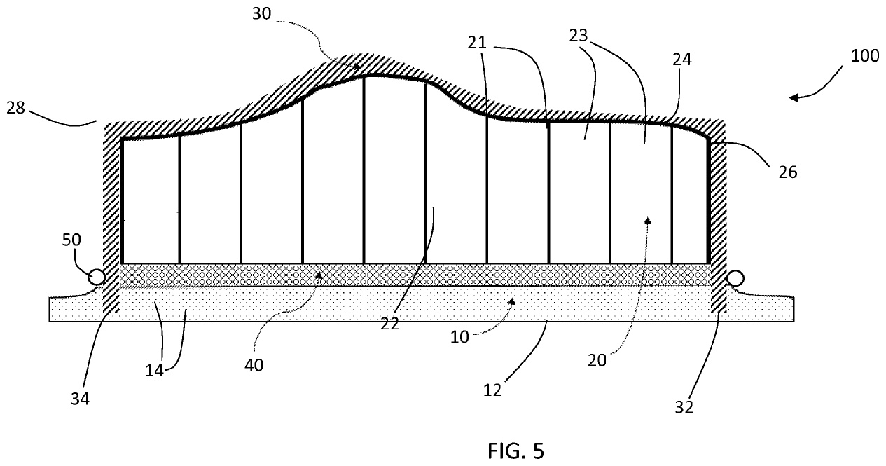

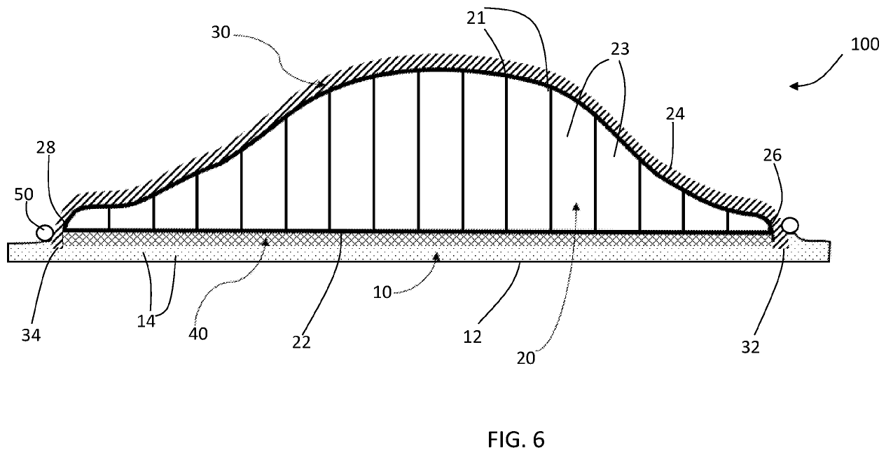

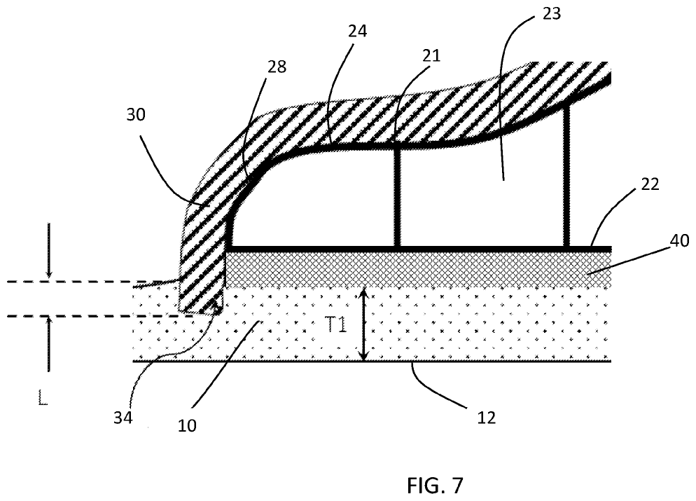

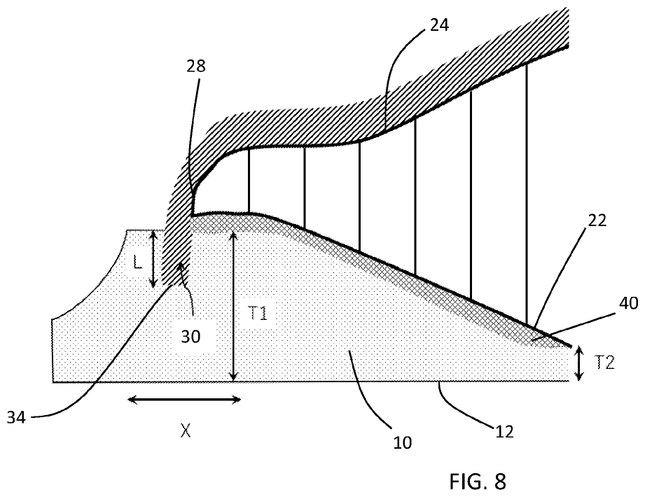

The thickness of the high gloss surface layer 10 is chosen to cover the underlying structure to a high quality, so that no bumps or the like occur or are recognizable at the surface of the high gloss surface layer 10. When the thickness of the high gloss surface layer 10 is reduced, the weight of the vehicle component 100 is reduced. However, when the thickness T1 of the high gloss surface layer 10 at a periphery region X where the ends 32, 34 of the encapsulating plastic layer 30 are inserted is too thin, the high gloss surface layer 10 in the periphery region X where the ends 32, 34 are inserted is broken due to cracking. Therefore, according to embodiments the high gloss surface layer 10 has a non-uniform thickness across its length, in which the thickness increases in the periphery region X as shown in FIGS. 4 and 8.

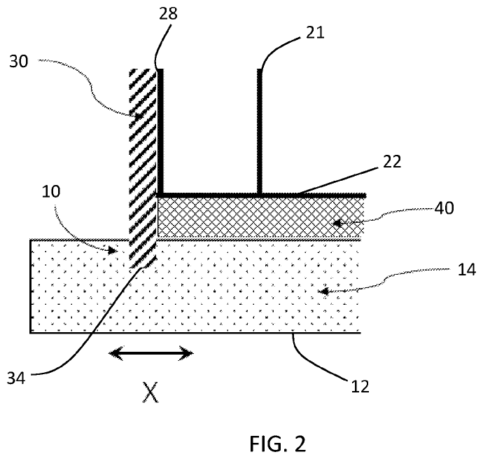

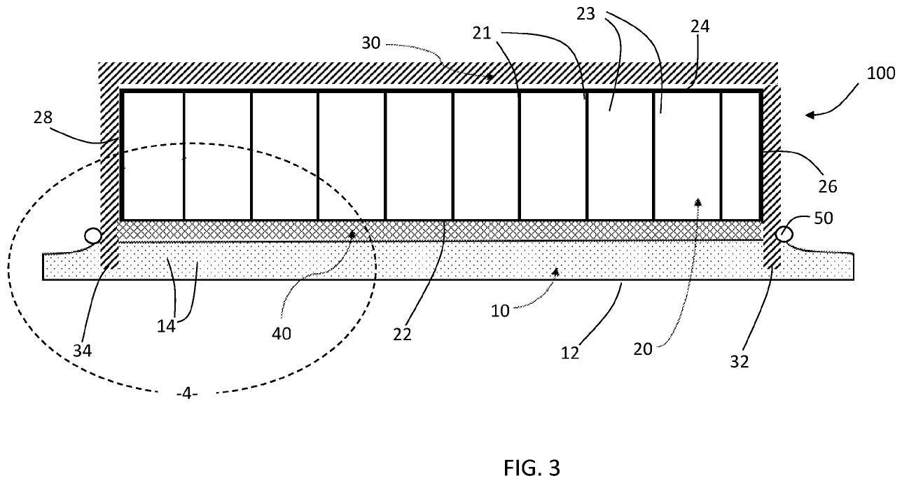

According to embodiments, the thickness T1 of the high gloss surface layer 10 is measured in a region X, which is a region within 5.0 mm from the insertion point of the ends 32, 34 of the encapsulating plastic layer 30, as shown in FIGS. 2, 4, and 8. According to embodiments, the thickness T1 of the high gloss surface layer 10 is between 1.0 mm and 4.0 mm. According to embodiments, a minimum thickness of 3 mm at region X is required to use a sharp edge 1303, but this may vary when different SMC grade is used to form the high gloss surface layer 10.

According to embodiments, the relationship between the thickness T1 of the periphery region X and a minimum thickness T2 of the high gloss surface layer 10 is 1.1<T1/T2. When it is 1.1<T1/T2, T2 is sufficiently smaller than T1. Therefore, the overall weight of the vehicle component 100 is reduced by reducing the thickness of the high gloss surface layer 10. According to embodiments, the relationship is 1.1<T1/T2<4.0, more preferably 1.3<T1/T2<3.5 even more preferably 1.5<T1/T2<3.0. According to embodiments, the minimum thickness T2 of the high gloss surface layer 10 is 0.5 mm to 3.0 mm, and more preferably, the thickness T2 is 1.0 mm to 2.0 mm.

According to embodiments, the open area core layer 20 is formed of a lightweight material that defines a plurality of pores 23 so as to reduce the overall density of the open area core layer 20. An open area core layer 20 according to the present invention is formed from a variety of materials that include cellulosics such as corrugated fiberboard, paper board, paper stock; phenolic resin, thermoplastics such as poly(methyl methacrylate) (PMMA), acrylonitrile butadiene styrene (ABS), polyamides, polylactides, polybenzimidazoles, polycarbonates, polyether sulfones, polyethylene, polypropylene, polystyrene, polyvinyl chloride, and block copolymers of any one of the aforementioned where at least one of the aforementioned makes up the majority by weight of the copolymer and regardless of the tacticity of the polymer or copolymer; thermosets such as polyesters, polyureas, polyurethanes, polyurea/polyurethanes, epoxies, vinyl esters; metal such as aluminum, magnesium, and alloys of any one of the aforementioned where at least one of the aforementioned metals constitutes the majority by weight of the alloy; a foam formed from polyurethane, polyethylene, ethylene vinyl acetate, polypropylene, polystyrene, polyvinyl chloride, oraerogels, regardless of whether the foam is open-celled or closed-celled.

The open area core 20 includes internal wall material 21 that defines a plurality of pores 24. The pores 24 may be disordered, such as when the open area core 20 is formed of a foam material, or may be in an ordered array, in which the pores are in a shape of honeycombs, diamonds, squares, triangles, parallelograms, circles, or a combination thereof. It is appreciated that while pores are depicted as isolated from one another that wall structures 21 are readily formed from extended folded strips that define a portion of several pores and when made contiguous with other such folded strips define an array of pores that are intercommunicative along the lines of contact between contiguous strips. According to embodiments, at least some pores 23 of the open area core 20 are in fluid communication with at least one other pore 23. According to embodiments, the fluid communication is established by forming a transverse hole through a side wall 21 of at least some of the pores 23. Such holes can be formed in the material of the open area core 20 before the material is formed into the pores of the open are core.

Alternatively, the holes allowing for fluid communication between the pores can be formed in the walls 21 of the core 20 after the pores 23 are formed. Fluid communication between at least some of the pores 23 ensures that air that is caught within a pore is able to move to another pore in the event that a given pore is crushed or otherwise deformed. As will be described in greater detail below, in some embodiments the edge region of the core material is crushed when the ends 32, 34 of the encapsulating plastic layer 30 are inserted into the high gloss surface layer 10 to form a sealed edge. In such situations, it is beneficial to provide transverse holes in the walls 21 of at least some of the pores 23, for example those near the edge to be sealed, such that when the seal is formed and the pores 23 near the edge are crushed, the air of those crushed pores is able to move into adjacent pores via the transverse holes.

According to embodiments, the pores 23 defined by walls 21 of the open area core layer 20 extend between first side 22 and the second side 24 of the open area core layer 20. In some embodiments, the internal wall material 21 is treated to modify a property thereof such as hydrophobicity or surface energy to promote adhesion thereto. By way of example, cellulosics are prone to moisture uptake and are readily coated with a wax such as a paraffin, or a silicone to render the cellulosic more hydrophobic compared to a native state. Alternatively, the cellulosic is readily alkylated by conventional reactions such as those with chloroacetic acid. Sarymsakov, A. A et al., Chem. Nat. Compd. (1997) 33: 337. Metals are similarly coated with a primer or other corrosion inhibitor. Alternatively, metals or polymers are plasma treated to modify surface energies to facilitate adhesion thereto.

In certain inventive embodiments, the ratio of the thickness of a wall 21 to the maximal linear extent between the first side 22 and the second side 24 of the open area core layer 20 is between 0.01-10:1. A wall 21 thickness ranges from 0.1 mm to 100 mm in such inventive embodiments. According to embodiments, the pores 23 of the open area core 20 include a fill, the fill being at least one of a sound dampening foam, a fire retardant, or a phase change material.

According to embodiments, the encapsulating plastic layer 30 predominantly contains polyurethane or is made of glass fiber reinforced plastic (GFRP) having a glass fiber mat impregnated with polyurethane. As shown in FIG. 1, the encapsulating plastic layer 30 is layered on the second side 24 of the open area core 20. According to embodiments, the encapsulating plastic layer 30 is fastened to the second side 24 of the open are core 20 using an adhesive. The adhesive is a polyurethane or polyurethane prepolymer adhesive, which may be in the form of glue, a moisture cure adhesive, a reactive hot melt adhesive, or a polyurethane resin. According to embodiments, due to the compressive force applied to the optional adhesive between the encapsulating plastic layer 30 and the open area core layer 20, the adhesive is engineered to have an initial viscosity on contact with the second side 24 of the open area core 30 and the walls 21 so as partially fill the pores 23 of the open area core layer 20. It is appreciated that the viscosity upon application is a function of factors that include application temperature, pore dimensions at the face, and intrinsic adhesive viscosity. The viscosity of the first adhesive layer ensures that the adhesive does not excessively run into the pores defined in the open area core layer 20 before the adhesive attains final strength.

According to embodiments, the high gloss surface layer 10 of the vehicle component 100 is connected to the open area core layer 20 by an internal plastic layer 40. According to embodiments, the internal plastic layer 40 formed from sheet molding compound (SMC), thermoplastic, dicyclopentadiene (DCPD), polyurethane (PU), or a combination thereof. According to embodiments, the internal plastic layer 40 includes a filler material to reinforce and/or serve to decrease the weight of the internal plastic layer 40. The filler material is any of glass fibers, carbon fibers, basalt fibers, natural fibers, hollow or solid glass microspheres, a fiber mat, or a combination thereof. The fibers may be oriented or non-oriented. It is appreciated that the internal plastic layer 40 may also include other additives to tune the properties thereof. Such additives routinely including glass fiber; carbon fiber; inorganic particulate fillers such as calcium carbonate, talc, and carbon black; glass microspheres; carbon nanotubes; graphene; low profile additives; moisture scavengers; and combinations thereof. According to embodiments, the internal plastic layer 40 may be omitted as a fibrous layer, if high gloss surface layer 10 takes over the structural properties of the internal plastic layer 40. In such situations, the bonding of high gloss surface layer 10 directly to the open area core layer 20 is then carried out only by an adhesive such as polyurethane or polyurethane prepolymer adhesive, which may be in the form of glue, a moisture cure adhesive, a reactive hot melt adhesive, or a polyurethane resin, as described above.

As shown in the figures, the first end 32 and the second end 34 of the encapsulating plastic layer 30 are folded down and wrapped over the ends 26, 28 of the open area core 20, such that the encapsulating plastic layer 30 covers the first end 26 and the second end 28 of the reinforcing open area core layer 20. With this design, the open area core layer 20 is not visible from the outside of the vehicle component 100 and the aesthetic at the ends of the vehicle component 100 is excellent and suitable for application on a vehicle without the need for additional finishing such as trimming or cutting. Furthermore, when the open area core layer 20 is made of a honeycomb, for example a paper honeycomb, not only does the encapsulating plastic layer 30 cover the ends 26, 28 of the core 20 to improve the aesthetics, but also the encapsulating plastic layer 30 seals the open area core layer 20 and prevents water and humidity infiltration into the open area core 20, which is particularly important when the vehicle component 100 is used as a vehicle exterior surface component given that such components are often directly in contact with snow, rain, and dew.

As noted above, the first end 32 and the second end 34 of the encapsulating plastic layer 30 are embedded into the high gloss surface layer 10 with an embedded length L. the ends 32, 34 of the encapsulating plastic layer 30 are held within the high gloss surface layer 10 by a friction fit or by an adhesive. Furthermore, a plasticizer may be placed on the ends 32, 34 of the encapsulating plastic layer 30 within the high gloss surface layer 10 to account for differences in thermal expansion of the respective materials. According to embodiments, the relationship between the length L and the thickness T1 of the high gloss surface layer 10 is T1×0.7>L. With this design, the first and second ends 32, 34 of the encapsulating plastic layer 30 is prevented from delamination, and the ends 26, 28 of the open area core layer 20 are covered from view and sealed off from the external environment. When the relationship between the length L and the thickness T1 of the high gloss surface layer 10 is T1×0.7>L, the high gloss surface layer 10 does not crack due to the insertion of the end 32, 34 of the encapsulating plastic layer 30. According to embodiments, the relationship between the length L and the thickness T1 is T1×0.5>L, and more preferably, T1×0.2>L. Whereas, when the lower limit of the insertion length L is L>T1×0.01 preferably, the ends 32, 34 do not easily peel off or come disconnected from the high gloss surface layer 30. According to embodiments, the lower limit of the insertion length L is L>T1×0.05, and more preferably L>T1×0.1.

Hereinafter, more specifically the insertion length L is explained. According to embodiments, the insertion length L is between 0.1 mm and 1.0 mm. In other words, the ends 32, 34 of the encapsulating plastic layer 30 are inserted into the high gloss surface layer 10 by 0.1 mm to 1.0 mm. When the insertion length L is 0.1 mm or more, the ends 32, 34 tend to not be easily peeled from the high gloss surface layer 10. Furthermore, when the insertion length L is 1.0 mm or less, the high gloss surface layer 10 is not destroyed by cracks due to the insertion of the ends 32, 34. The insertion length L is more preferably between 0.2 mm and 0.8 mm, and even more preferably between 0.3 mm and 0.6 mm.

According to embodiments, a sealant 50 is applied to the exterior of the encapsulating plastic layer 20 where it intersects with the high gloss surface layer 10. The sealant 50 act as an adhesive to help hold the encapsulating plastic layer 20 in its position inserted in the high gloss surface layer 10 as well as helping to further seal the encapsulating plastic layer 20 and the high gloss surface layer 10 to prevent moisture infiltration into the open area core layer 20.

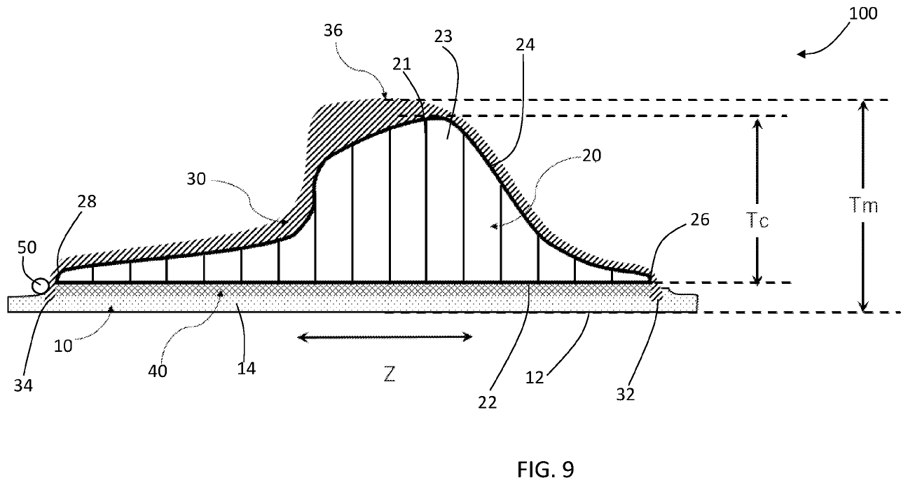

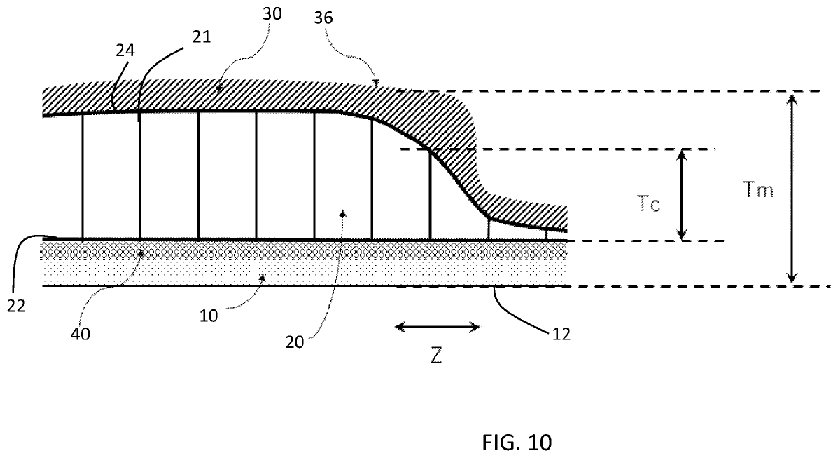

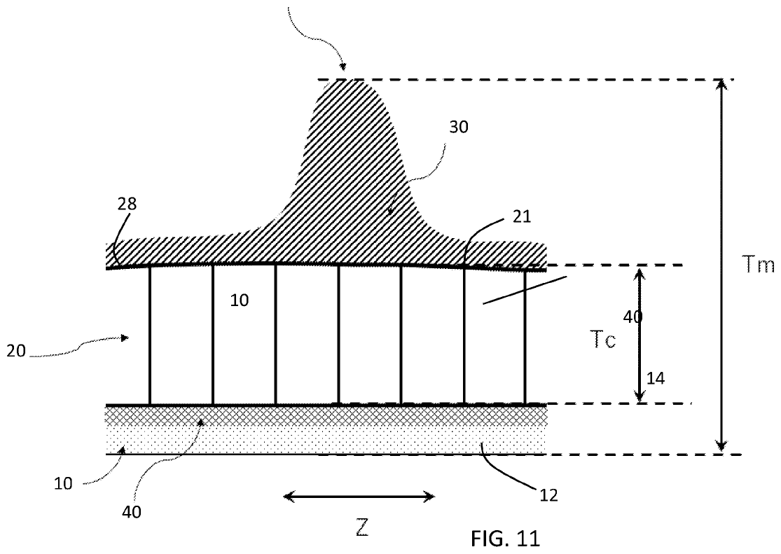

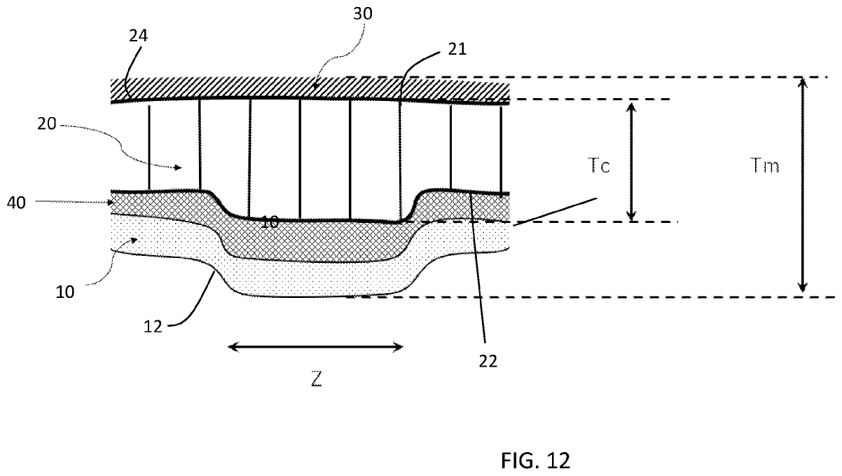

In the present invention, the vehicle component 100 has a region Z in which a relationship between a thickness Tm of the vehicle component 100 and a thickness Tc of the open area core layer 20 is Tm−Tc>Tc×0.2. According to embodiments, the region Z does not need to occupy the entire vehicle component 100. It is sufficient that at least a part of the vehicle component 100 has the region Z that satisfies Tm−Tc>Tc×0.2. For example, as illustrated in FIGS. 9-12, the thickness Tm of the vehicle component 100 is the thickness of the vehicle component 100 and Tc is the thickness of the open area core layer 20. According to embodiments, when a vehicle component 100 has a higher Tm thickness than the thickness of the open area core 20 Tc, it is necessary to fill the space between the high gloss surface layer 10 and the open area core 20 with additional material either on the encapsulating plastic layer 30 or the internal plastic layer 40. For example, when a shape of the vehicle component 100 has a projection inward as shown in FIGS. 9-11, a space between the open area core layer 20 and the inner surface 36 of the vehicle component 100 is filled with additional material on the encapsulating plastic layer 30. Alternatively, when the shape of the vehicle component 100 has a projection outward as shown in FIG. 12, a space between the open area core layer 20 and the high gloss surface layer 20 is filled with additional material on the internal plastic layer 40.

According to embodiments, the vehicle component 100 is a vehicle exterior surface component. Such a vehicle exterior surface component is for example a body component, a cover of a roof opening system like a sun roof or a spoiler roof, a surface component of a roof module or a lining construction unit of a vehicle. When the vehicle component 100 is a vehicle exterior surface component, an IMC-TOP coat layer may be provided on the high gloss surface layer 10. The IMC-TOP coat layer may be attached on the outside of the high gloss surface layer 10, which forms the outer shell layer together with the high gloss surface layer 10.

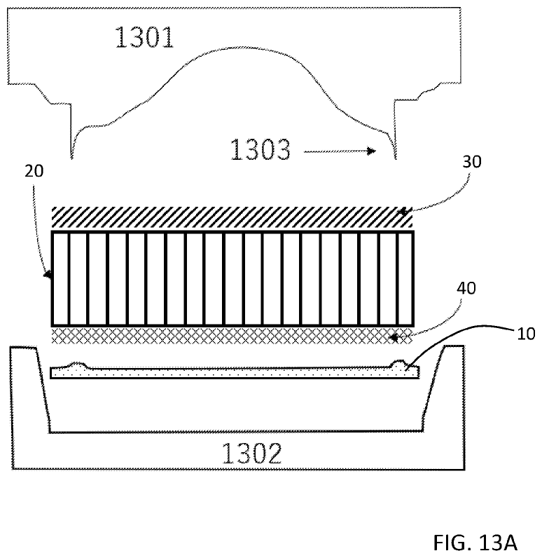

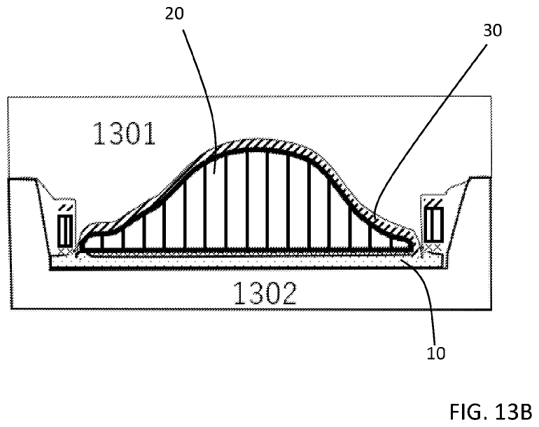

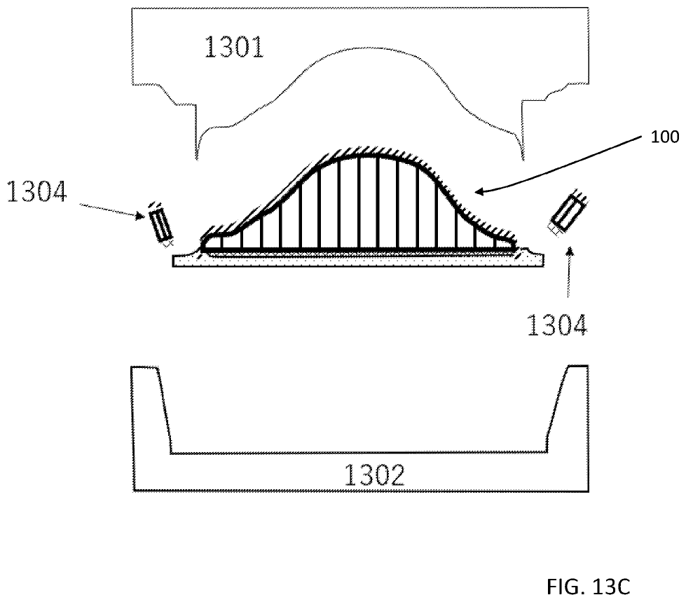

The present invention additionally provides a method for producing the light and resilient vehicle component 100 described above. As shown in FIGS. 13A-13C, the inventive method includes stacking the high gloss surface layer 10, the open area core layer 20, and the encapsulating plastic layer 30 in a mold 1301, 1302. According to embodiments, the method also includes layering a second plastic layer 40 between the high gloss surface layer 10 and the open area core 20. As shown, the open area core layer 20 and the encapsulating plastic layer 30, and if present the internal second plastic layer 40 are provided with a length that is greater than the desired vehicle component 100 length.

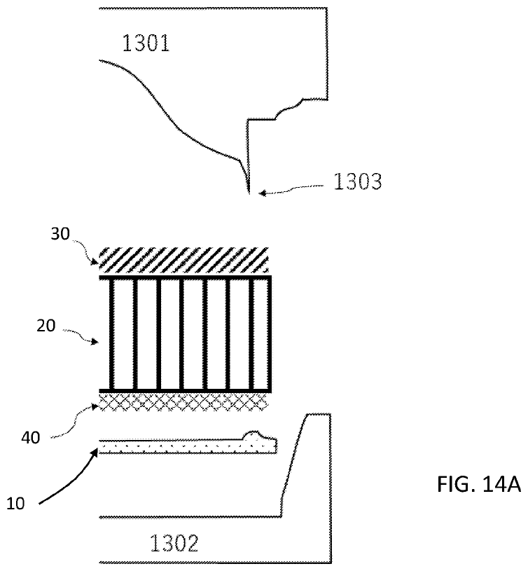

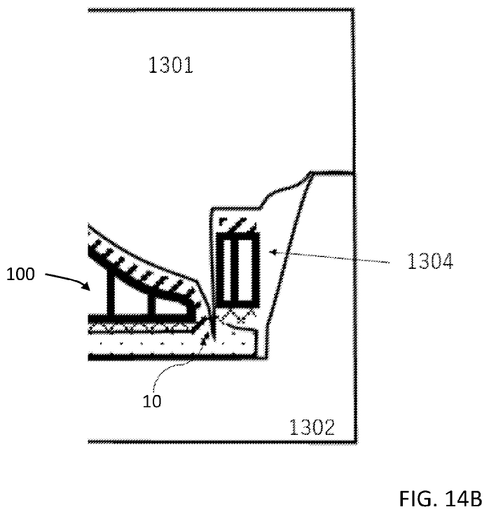

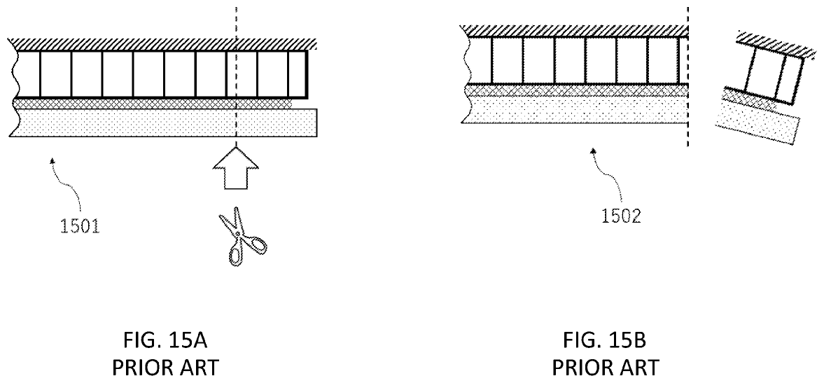

The method continues by inserting the ends 32, 34 of the encapsulating plastic layer 30 into the high gloss surface layer 10 using a sharp edges 1303 provided on either an upper mold 1301 or the lower mold 1302 as shown in FIGS. 14A and 14B. With the insertion of the ends 32, 34 into the high gloss surface layer 10, the sharp edges 1303 simultaneously cut the encapsulating plastic layer 30, the open area core layer 20, and, if present, the second internal plastic layer 40, leaving a trimmed portion 1304 outside and separate from the vehicle component 100. This is in contrast to existing processes, such as that shown in FIGS. 15A and 15B, in which after removing a formed sandwich structure vehicle component from a mold, at least one further method step, such as trimming or cutting the edges is necessary to obtain aesthetically appropriate component edges. Thus, the inventive method is an improvement over existing processes in that the inventive method reduces the manufacturing steps, thereby increasing manufacturing throughput and reducing manufacturing costs.

The method continues by pressing the upper mold 1301 and the lower mold 1302 together to impart a shape to the vehicle component 100. According to embodiments, a vacuum is applied to the mold cavity to further assist in shaping the vehicle component 100.

According to embodiments, the sharp edge 1303 penetration is controlled by the tool, and hard stops with adjustable shims may set the penetration distance. Furthermore, according to embodiments, an IMC thin layer can be provided with an outer surface coating or alternatively the high gloss surface layer 10 can be provided with a paintable IMC thin layer and the method may then include painting the vehicle component 100. Furthermore, an IMC lacquer layer may be applied to the high gloss surface layer 10 on a side that is facing the first mold 1302 to form an outer skin layer in the process.

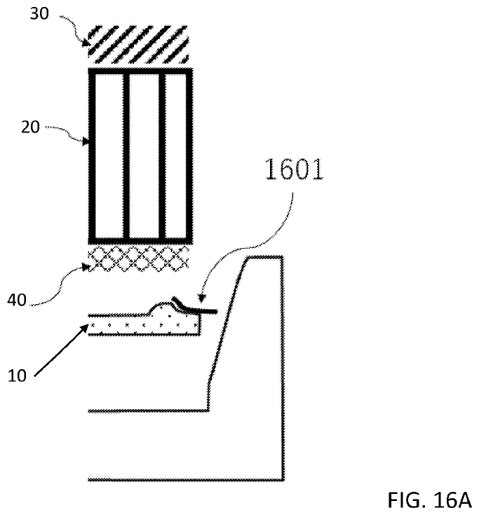

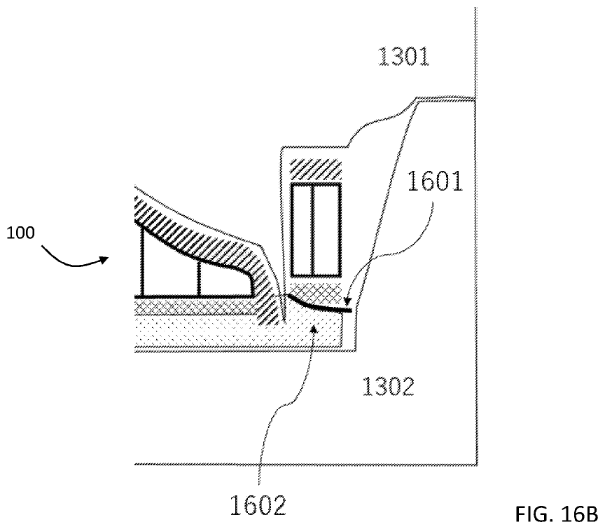

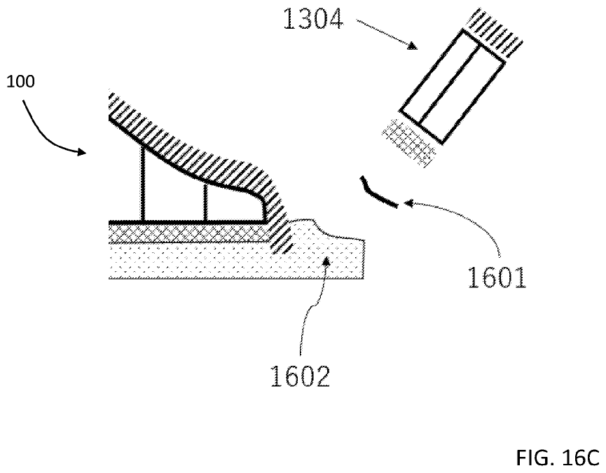

According to embodiments, such as shown in FIGS. 16A-16C, the method includes masking the ends of the high gloss surface layer 10 with a mask 1601 at the time of molding in order to prevent any adhesion marks or other scaring on the high gloss surface layer 10 during the molding process.

The foregoing description is illustrative of particular embodiments of the invention but is not meant to be a limitation upon the practice thereof. The following claims, including all equivalents thereof, are intended to define the scope of the invention.

1. A vehicle component unit comprising:
a reinforcing open area core layer having a first side and an oppositely opposed second side and a first end and an oppositely opposed second end each extending between the first side and the second side;
a high gloss surface layer positioned on the first side of the reinforcing open area core layer; and
an encapsulating plastic layer having a first end and a second end, the encapsulating plastic layer positioned on the second side of the reinforcing open are core layer, the first end and the second end of the encapsulating plastic layer being embedded into the high gloss surface layer with an embedded length L, such that the encapsulating plastic layer covers the first end and the second end of the reinforcing open area core layer.

2. The vehicle component unit of claim 1, wherein a relationship between the embedded length L and a thickness T1 of the high gloss surface layer is T1×0.7>L.

3. The vehicle component unit of claim 1, wherein the embedded length L is between 0.1 mm and 1.0 mm.

4. The vehicle component unit of claim 1, wherein the reinforcing open area core layer is an array of a pattern of at least one shape of: hexagonal, circular, rhomboidal, triangular, parallelogram quadrilateral, or regular quadrilateral.

5. The vehicle component unit of claim 1, wherein the reinforcing open area core layer is formed of at least one of: cellulosics, thermoplastic, thermoset, metal, or foam.

6. The vehicle component unit of claim 2, wherein the thickness T1 of the high gloss surface layer is measured in a region X that is within 5.0 mm from a point where the first end or the second end of the encapsulating plastic layer is inserted into the high gloss surface layer.

7. The vehicle component unit of claim 6, wherein a relationship between the thickness T1 of the region X and a minimum thickness T2 of the high gloss surface layer is 1.1<T1/T2.

8. The vehicle component unit of claim 2, wherein the thickness T1 is between 1 mm and 4 mm.

9. The vehicle component unit of claim 1, wherein the vehicle component unit has a region Z in which a relationship between a thickness Tm of the vehicle component unit and a thickness Tc of the reinforcing open area core layer is Tm−Tc>Tc×0.2.

10. The vehicle component unit of claim 1, wherein a space between the reinforcing open area core layer and the high gloss surface layer is filled with a second plastic layer.

11. The vehicle component unit of claim 1, wherein the high gloss surface sheet is formed of any one of: sheet molding compound (SMC), thermoplastic sheet, dicyclopentadiene (DCPD), or polyurethane (PU).

12. The vehicle component unit of claim 1, wherein the high gloss surface sheet comprises a filler of at least one of: glass fiber, carbon fiber, carbon nanotubes, graphene, inorganic particulate fillers, glass microspheres, low profile additives, or moisture scavengers.

13. The vehicle component unit of claim 1, further comprising a fill in pores of the reinforcing open area core, the fill being at least one of a sound dampening foam, a fire retardant, or a phase change material.

14. The vehicle component unit of claim 1, wherein the high gloss surface layer and the encapsulating plastic layer form a moisture resistant seal.

15. A method for producing the vehicle component unit of claim 1, the method comprising:
stacking the high gloss surface layer, the open area core layer, and the encapsulating plastic layer in a mold having an upper portion and a lower portion that together define a mold cavity;
inserting the ends of the encapsulating plastic layer into the high gloss surface layer using sharp edges on the mold and simultaneously trim the encapsulating plastic layer and the open area core layer using the sharp edges on the mold; and
pressing the upper portion of the mold and the lower portion of the mold together to impart a shape to the vehicle component.

16. The method of claim 15 further comprising applying a vacuum to the mold cavity to shape the vehicle component.

17. The method of claim 15 further comprising layering a second plastic layer 40 between the high gloss surface layer 10 and the open area core 20.

18. The method of claim 17 wherein the sharp edges of the mold also trim the second plastic layer.

19. The method of claim 15 wherein the open area core layer and the encapsulating plastic layer have a length that is greater than the length of the vehicle component.

20. The method of claim 15 further comprising masking ends of the high gloss surface layer with a mask.
